(19) United States
(12) Patent Application Publication
(10) Pub. No.: US 2008/0140621 A1
(43) Pub. Date: Jun. 12, 2008

(54) SYSTEMS AND METHODS FOR CREATING PERSISTENT SEARCHES

(75) Inventors: Ronald Martinez, San Francisco, CA (US); Rajat Mukherjee, San Jose, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/609,191

(22) Filed: Dec. 11, 2006

(51) Int. Cl. G06F 17/30

(52) U.S. Cl. 707/3; 707/E17.001

(57) ABSTRACT

One aspect is a method for customizing a feed, the method including receiving a request from a user for a feed, the feed including an item from a pre-identified corpus of item sources, the item being associated with a search term. This aspect further includes initiating a search using the search term, wherein the search is for items associated with the search term, the items referenced by at least one of the pre-identified corpus of item sources. This aspect further includes creating the feed.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The expansion of the Internet and the World Wide Web (“web”) has given computer users the enhanced ability to listen to and to watch various different forms of media content through their computers. Such content can be in the form of audio music, music videos, television programs, sporting events or any other form of audio or video content that a user wishes to watch, read, listen to or otherwise perceive in some manner.

The web has changed publication and distribution models for media and information. Many electronic formats have been developed that enable different modes of publication and distribution. RSS is a family of markup language file formats for web syndication used by (amongst other things) news websites and weblogs. The RSS abbreviation is used to refer to the following standards: Rich Site Summary (RSS 0.91); RDF Site Summary (RSS 0.9 and 1.0); and Really Simple Syndication (RSS 2.0).

The technology behind RSS allows a client to subscribe to websites that have provided RSS feeds; these are typically sites that change or add content regularly. Software has been developed to use these feeds and other types of feeds. To use this technology the client often uses some type of aggregation service or aggregator. The aggregator allows a client to subscribe to the publishing sites (e.g., websites, locations which have feeds) from which the client wants to get updates.

The RSS formats provide web content or summaries of web content together with links to the full versions of the content, and other meta-data. This information is delivered as an extensible markup language (XML) file, sometimes termed an RSS feed, webfeed, RSS stream, or RSS channel. In addition to facilitating syndication, RSS allows a website's frequent readers to track updates on the site using an aggregator.

RSS is widely used by the weblog community to share the latest headlines or their full text, and even attached multimedia files. In mid 2000, use of RSS for podcasting text spread to many major news organizations, including Reuters, CNN and the BBC, until under various usage agreements, providers allow other websites to incorporate their “syndicated” headline or headline-and-short-summary feeds. RSS is now used for many purposes, including marketing, bug-reports, or any other activity involving periodic updates or publications.

A program known as a feed reader or aggregator can check RSS-enabled webpages on behalf of a user and display any updated articles that it finds. It is now common to find RSS feeds on major web sites, as well as many smaller ones. RSS search engines (e.g., Feedster) may search RSS feeds for particular items matching a search term.

Client-side readers and aggregators are typically constructed as standalone programs or extensions to existing programs like web browsers. Such programs are available for various operating systems.

### SUMMARY

The following description of various embodiments is merely exemplary in nature and is in no way intended to limit the invention, its application, or uses.

One aspect is a method for customizing a feed, the method including receiving a request from a user for a feed, the feed including an item from a pre-identified corpus of item sources, the item being associated with a search term. This aspect further includes initiating a search using the search term, wherein the search is for items associated with the search term, the items referenced by at least one of the pre-identified corpus of item sources. This aspect further includes creating the feed.

In one embodiment, the method includes transmitting a plurality of item sources, receiving a selection of the plurality of item sources from the user, and creating the pre-identified corpus of item sources based on the selection received from the user. In another embodiment, initiating includes sending a search request to a third-party search engine. In another embodiment, initiating includes performing the search.

In one embodiment, the method includes determining one or more previously generated search results. In another embodiment, determining the one or more previously generated search results is performed based on the time the request from the user was received. In another embodiment, the method includes removing from the feed an item which is part of the one or more previously generated search results.

In one embodiment, the feed is a markup language document. In another embodiment, the request is automatically generated by a computing device associated with the user. In another embodiment, creating the feed includes updating an earlier version of the feed.

Another aspect is a method including receiving a first request from a user to create a feed, the feed including an item, the item being associated with a search term, initiating a first search using the search term, wherein the first search is for one or more item sources. This aspect further includes transmitting, to the user, the one or more item sources, receiving, from the user, a selection of at least one item source from the one or more item sources, and initiating a second search of the selected at least one item source using the search term, wherein the second search is for items associated with the search term. This aspect further includes creating the feed using items identified in the second search.

In one embodiment, the first request includes the search term. In another embodiment, the method includes receiving a second request from the user, the second request being a request for the feed. In another embodiment, the method includes initiating the second search in response to the second request. In another embodiment, the method includes retrieving, in response to the second search request, the search term and the selected at least one item source. In another embodiment, the method further includes transmitting the feed to the user.

In one embodiment, the method includes storing search criteria associated with the user, the search criteria identifying the search term and the selected at least one item source. In another embodiment, the feed is a markup language document. In another embodiment, initiating the first search includes sending a search request to a third-party search engine. In another embodiment, initiating the first search includes performing the first search.

Another aspect is a system including a search criteria manager that receives search criteria associated with a user, the search criteria including a first item source and a search term. This aspect further includes a search manager in communication with the search criteria manager, wherein the search manager initiates a first search, wherein the first search is for items associated with the search term, the items referenced by the first item source. This aspect further includes a feed manager in communication with the search criteria manager and with the search manager, wherein the feed manager formats items contained in a first result of the first search as a feed and makes the feed available to the user.

In one embodiment, the search manager initiates a second search for second item sources, the second search using the search term. In another embodiment, the search criteria manager transmits a plurality of second item sources to the user and receives a selection of the second item sources from the user. In another embodiment, the first item source is part of the selection of the second item sources received from the user. In another embodiment, the feed manager transmits the feed to the user.

In one embodiment, in response to a subsequent request for the feed, the search criteria manager updates the feed by requesting the search manager to initiate a third search of the first item source, wherein the third search is for items associated with the search term, the items referenced by the first item source. In another embodiment, the system includes a timing module in communication with the search criteria manager, wherein the timing module instructs the search criteria manager to update the feed. In another embodiment, the search criteria manager stores a first time, the first time corresponding to the time the first search was performed. In another embodiment, the search criteria manager requests the feed manager to update the feed only with items that were published after the first time. In another embodiment, the feed is a markup language document.

### A BRIEF DESCRIPTION OF THE DRAWINGS

FIG. 1 is a schematic of an embodiment of a system for managing search criteria.

FIG. 2 shows a flow chart of an embodiment of a method of creating a feed comprising items associated with a search term.

FIG. 3 shows a flow-chart of an embodiment of a method for creating a corpus of item sources.

FIG. 4 shows a flow chart of an embodiment of a method for updating a feed.

FIG. 5 shows a flow chart of an embodiment of a method for creating a feed.

FIG. 6 shows a flow chart of an embodiment of a method of performing a search for items based on another triggering event.

### DETAILED DESCRIPTION

The following description of various embodiments is merely exemplary in nature and is in no way intended to limit the invention, its application, or uses. While various embodiments have been described for purposes of this specification, various changes and modifications may be made which will readily suggest themselves to those skilled in the art and which are encompassed in the spirit of the invention both disclosed herein and as defined in the appended claims.

Methods and systems are described herein for creating a feed of search results from search criteria initially provided by a user or other entity. This is useful for a user who wishes to automatically perform the same search repeatedly over a period of time and easily identify any new search results. For example, a user may provide a set of search criteria such as keywords and selection of sources to search from which a feed of search results is created. The user may then subscribe to this feed and, on each future request for the feed, be provided with an updated feed containing the current or updated results of originally provided search criteria.

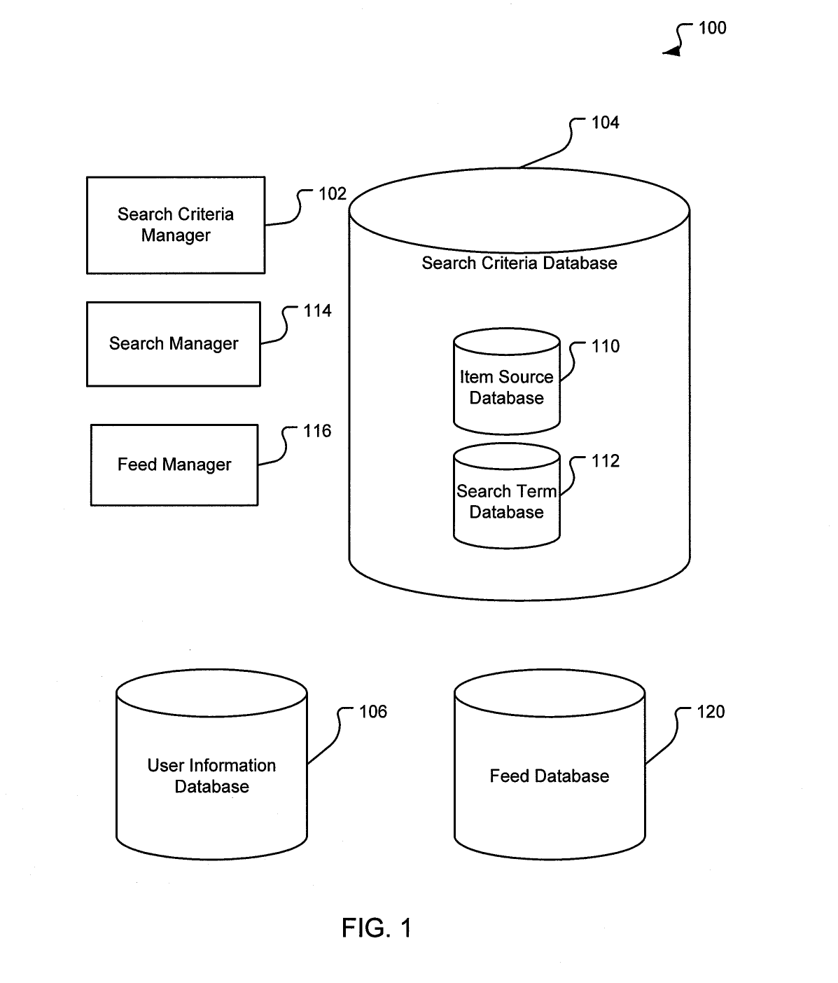

FIG. 1 is a schematic of an embodiment of a system 100 for managing search criteria. In one embodiment, a search criteria manager 102 creates and updates search criteria based on received requests. The search criteria may be used by other elements of the system 100 to create a persistent search for an entity, the search being persistent because it is performed using a search term on a defined corpus of item sources. Search criteria may include one or more search terms, and one or more item sources. In some embodiments, search criteria may include an indication of which items referenced by the source(s) have been accessed or made accessible.

In one embodiment, a feed may be used by the system 100 to create a persistent search for a user through updating the feed with items resulting from a search using search criteria stored or otherwise maintained. For example, the search criteria manager 102 may initiate the creation and updating of feeds containing items returned from searches using search criteria stored for a persistent search. In one embodiment, search criteria initially provided by the user are stored remotely and accessed from a memory in response to an updated feed being requested, so that for each request a new, updated feed is generated.

A request received by the search criteria manager may be of many types. For example, such requests may include, a request from an entity for a feed, a request from an entity for a search to be performed, or an entity requesting that a persistent search of one or more item sources using a search term be performed. In one embodiment, the search criteria manager 102 uses search criteria to create a search which may be repeated on the same source(s) using the same term and which will return items which have not been accessed before. In another embodiment, the search criteria manager requests that a feed manager create a feed with one or more search terms and one or more sources, with the feed also containing an element indicating the last time it was accessed and an element containing the publication time of at least one item in the feed which is referenced by one of the source(s).

In one embodiment, the search criteria manager 102 will update the feed at certain times without the receipt of a request for the feed. In one embodiment, the search criteria manager may follow a schedule for updating the feed. In another embodiment, the search criteria manager may update the feed based on a triggering event, such as information from an item source (e.g., an item source included in the search criteria associated with the feed) that the item source has new items. In one embodiment, the search criteria manager may update a feed when a user's presence is detected (e.g., the user logs on to a server).

A search manager may be used to perform or to request searches from a third-party searching source (e.g., a third-party search engine). The search manager 114 receives search criteria from the search criteria manager 102 and the search manager initiates a search using the search criteria. In one embodiment, the search manager 114 initiates a search by performing the search itself. In another embodiment, the search manager 114 initiates a search by sending the search criteria in a request to a search engine operated by a third-party. In one embodiment, the search manager 114 receives results from the search and may pass the results to another entity in the system (e.g., a feed manager). In another embodiment, the search manager does not receive the results from the search. In yet another embodiment, the search manager may receive an indication that the search was performed.

Methods and systems for performing searches are known by those with skill in the art. A search manager may incorporate any such systems and/or use any such methods, or may request that a third party (which may incorporate any such systems) use such methods.

A feed manager may create a feed of items from a search result. In one embodiment, a feed manager creates the feed in response to a request to read the feed, which may or may not exist when the request is received.

In some embodiments, the feed manager may create a feed and make it available (and/or store it) long enough for an entity which requested the feed to read the feed. In one embodiment, the feed manager may store the feed in a memory, such as a feed database 120. In some embodiments, the feed manager may transmit data containing items from search results in a format similar to that of a feed (e.g., a markup language, such as XML) in response to an entity requesting to read a feed. In one embodiment, the feed manager may present search results to a user in other formats. In another embodiment, the feed manager may retrieve a feed from memory, update it to reflect new search results, and make the feed available.

In one embodiment, the search criteria manager 102 may request a search (e.g., from the search manager 114, from a third party search engine) for item sources, and request that the search for item sources use a search term or other search criteria. An item source may be a separate database of items, a categorization of items or some other previously created group or set of items. For example, an item source may be a database of music items. As another example, an item source may be those items categorized as news items in an index. In some embodiments, the search term is part of the search criteria from a user. In other embodiments, the search term is selected by the search criteria manager based on the search term being sponsored or based on the search term being similar or suggestive of search criteria from a user.

The search criteria manager 102 may select item sources or aid a user in selecting item sources. In one embodiment, the search criteria manager transmits item sources for selection by a user and receives a selection of the item sources from the user. In another embodiment, the search criteria manager may select item sources for a user before sending the item sources to the user for the user's selection therefrom. For example, the search criteria manager may request a search for item sources based on any of the search criteria. In one embodiment, the search criteria manager receives a selection of item sources from a user. In another embodiment, the search criteria manager selects item sources based on search criteria already entered by a user. In one embodiment, the search criteria manager selects item sources based on search criteria entered by a user in another search or at another time. For example, the search criteria manager may request a search for item sources based on user information such as a user's history of usage of a feed, a user's search history, or a user's preferences.

In one embodiment, the search criteria manager 102 presents a list of item sources to a user and receives from the user a selection of item sources from the list. In another embodiment, the search criteria manager presents a list of items to a user and receives from the user a selection of items from the list. In one embodiment, the search criteria manager presents a list of items with the respective item sources designated and receives a selection from the list from the user. For example, a user may wish to select an item based on the item source or vise versa. In one embodiment, the search criteria manager may include multiple items from a single item source to aid the user in selection of an item source. In another embodiment, the search criteria manager may include only one example item from an item source presented to the user for selection of item sources. In one embodiment, the search criteria manager interprets the selection of an item and its designated item source as a selection from the user of the item source.

The search criteria manager 102 may include sponsored search criteria in search criteria such as sponsored search term(s), sponsored item source(s). In one embodiment, the search criteria includes a sponsored item source in search criteria. In another embodiment, the search criteria manager may present a sponsored item source to a user for selection by the user into the search criteria.

A search term may be included in search criteria based on a suggestion from the search criteria manager 102. In one embodiment, a search term may be a sponsored search term and may be included in search criteria associated with a user because the sponsored search term is related to a search term requested by a user or because the sponsored search term is related to an item source requested by the user. For example, a sponsored search term may be sponsored by an entity which wants any searches using a certain search term or item source to also include the sponsored search term.

In one embodiment, a sponsored search term is shown to a user. In one embodiment, the search criteria manager may request and accept a user's input as to whether a sponsored search term should be included in the user's search criteria. In another embodiment, a sponsored search term is included in search criteria without notification of a user.

A feed may include sponsored items. In one embodiment, a sponsored item may be included in results of searches that are included in a feed. In another embodiment, a sponsored item may be included by the search manager 114 or the search criteria manager 102. In one embodiment, a sponsored item may be referenced by a sponsored item source. In another embodiment, a sponsored item may be referenced by an item source which is not sponsored. In yet another embodiment, a sponsored item may be referenced by an item source which is not part of the search criteria. In one embodiment, a sponsored item may contain a sponsored search term. In another embodiment, a sponsored item may contain a non-sponsored search term. In yet another embodiment, a sponsored item may not contain a search term which is part of the search criteria.

In one embodiment, the search criteria are included in a feed. For example, the one or more search terms may be stored in search element(s) within the feed, the one or more sources may be stored in source elements within the feed, and an indication of which items referenced by the source(s) have been accessed may be stored in a number of ways. Those skilled in the art will understand the manners of use of elements within markup languages and RSS-compatible languages. In one embodiment, a feed may contain all of the information that the search criteria contains. In another embodiment, there may be distinctions between the information contained in a search criteria and a feed associated with it. In one embodiment, a time at which the feed has most recently been accessed (or requested) may be stored in an element and publication times of items referenced by the source(s) may be compared against the most recent access time to determine whether the item has been accessed. In another embodiment, a listing or cataloging of items which have been accessed may be stored.

A request for the feed may be received by any part of the system. For example, in one embodiment, the request may be received by the search criteria manager 102. In another embodiment, the request may be received by the feed manager 116.

Search criteria may be associated with a user in a number of ways. For example, search criteria may be contained in a search criteria database 104 and may be linked to user information in a user information database 106. In one embodiment, a user may identify himself to the system and his information may be associated with a number of search criteria, including search criteria he creates after identifying himself. For example, a user may create several persistent searches to which he may subscribe and may monitor those searches using a feed aggregator or a feed reader.

In some embodiments, search criteria may be associated with a number of users. For example, a server may host a feed associated with search criteria established for a group of individual users. In one embodiment, a feed may be generated for each one of the entities (e.g., users). In another embodiment, search criteria may be created for each entity.

It will be understood by those with skill in the art that a user may request a feed through an intermediary, such as an aggregator or a reader, and that a user may link any action with an intermediary's request for a feed. For example, a user may make a request by establishing a standing request that an intermediary make a request for a feed at certain intervals, certain times, when a computer is started, when a program is run, etc.

In one embodiment, search criteria are stored in a search criteria database 104. In the embodiment shown, search criteria (e.g., a listing of one or more search terms and one or more item sources) may be stored in a search criteria database 104 containing a item source database 110 and a search term database 112. In another embodiment, search criteria may be stored with information from the user information database (e.g., 106). In one embodiment, search criteria may be restricted by user profile information, for example, such as user name or password. In another embodiment, search criteria may be accessible by many users and may not be assigned to any one user.

Elements of the systems described herein may be implemented in hardware, software, firmware, any combination thereof, or in another appropriate medium. The systems described herein may implement methods described herein. In addition methods described herein when implemented in hardware, software, firmware, any combination thereof, or in another appropriate medium may form systems described herein. Therefore, the descriptions of the methods and systems herein supplement each other and be understood by those with skill in the art forming a cumulative disclosure.

The methods described herein may be performed by any part of an element of a system described herein. In addition, the methods described herein may be performed iteratively, repeatedly, and/or in parts. In addition, some of the methods or parts of the methods described herein may be performed simultaneously. In addition, elements of the systems described herein may be distributed geographically or functionally in any configuration.

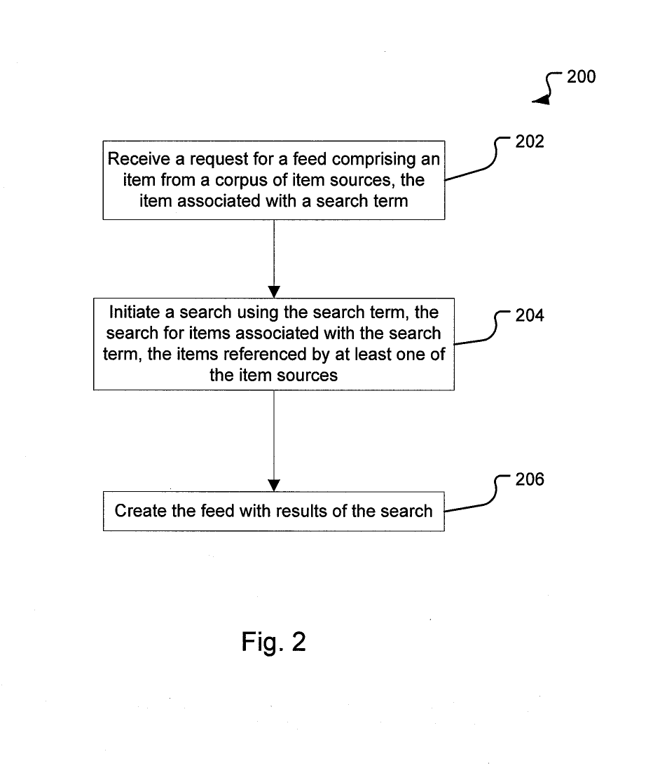

FIG. 2 shows a flow chart of an embodiment of a method 200 of creating a feed comprising items associated with a search term. Method 200 includes receiving a request for a feed comprising an item from a corpus of item sources and the item being associated with a search term. In one embodiment, the request received is a request from a feed aggregator for a feed at a location associated with the feed by the feed aggregator. In one embodiment, the feed requested does not exist when it is request, but is created 206 in response to receiving a request for the feed. In another embodiment, the feed requested in 202 does exist when the feed is requested. The feed may or may not reside in the location where the feed is requested, though a request for the location may be interpreted as a request to present the feed. In one embodiment, the method 200 includes interpreting the request received (not shown) as a request to access a persistent search which has been previously created.

In the embodiment shown, the requested feed is created 206 in response to the request for the feed. In one embodiment, an older version of the feed already exists and an updated version of the feed is created 206. In another embodiment, a feed does not exist when the request is received 202.

In response to a request received in 202, a search is initiated 204 using a search term. In one embodiment, the search term is retrieved from search criteria stored from a previously saved persistent search (e.g., stored as described further herein). In another embodiment, the search term is contained in the request received in 202.

The search initiated in 204 is a search for items associated with the search term and referenced by at least one of a group or corpus of item sources. In one embodiment, the group or corpus of item sources may be stored as search criteria stored for a persistent search. In another embodiment, the group or corpus of item sources may be received as part of the request or separately.

In one embodiment, the request received in 202 is for a feed at a location and the location of the feed contains identifying information sufficient to identify search criteria associated with the feed (e.g., the search criteria which is used to create the feed via initiating a search using the search criteria and creating a feed with the results). In another embodiment, the request received in 202 is for a feed at a location (e.g., a URL address) and the location of the feed contains the search criteria in the text of the location. In one embodiment, the request received in 202 is interpreted along with other information (e.g., user information from a presently logged-on user) to identify search criteria with which the feed is associated.

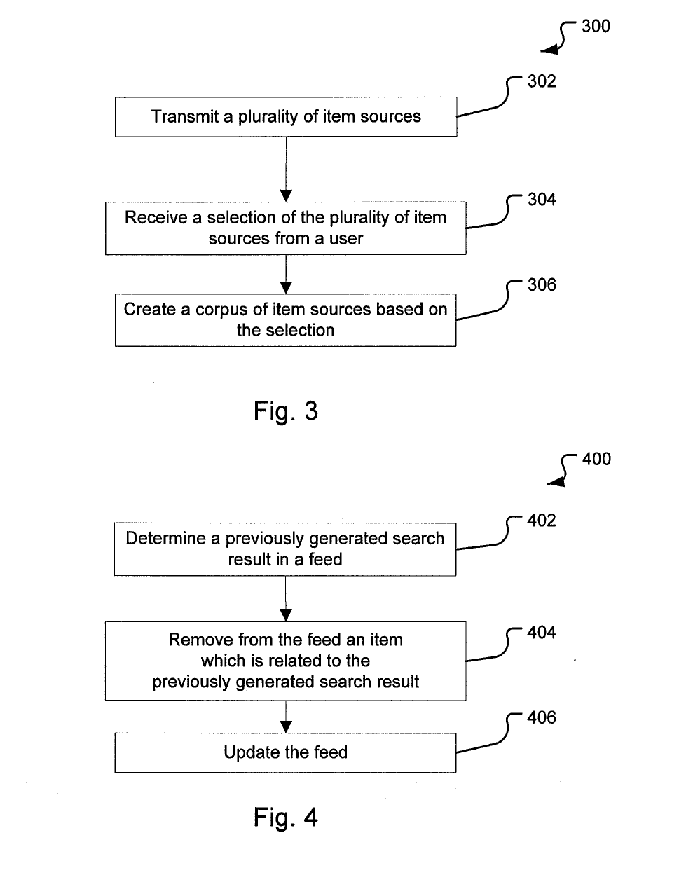

FIG. 3 shows a flow-chart of an embodiment of a method 300 for creating a corpus of item sources. A plurality of item sources, identified and grouped as discussed further herein, are transmitted to an entity, for example, a user. Transmitting the plurality of item sources 302 may be performed in many ways. Those with skill in the art will understand the many ways to transmit things, particularly to a user. For example, transmitting may include presenting a graphical user interface, presenting a webpage, sending a list, or populating a form with options for presentation to a user.

A selection of the plurality of item sources are received from a user 304. In one embodiment, the selection is associated with the user. For example, the selection may be used in creating search criteria associated with the user. In one embodiment, a corpus of item sources is created based on the selection 306. For example, the selection may be incorporated into a list along with other sources, such as sponsored sources or other suggested sources.

In one embodiment, a corpus of item sources is a group of item sources, such as a list of item sources. In another embodiment, a corpus of item sources is a grouping of both item sources and attributes of item sources. For example, attributes of item sources include the content types available from item sources chosen by a user, suggested, sponsored or otherwise associated with a user. In one embodiment, a user may indicate attributes of item sources to include or be aware of attributes assigned to the selected item sources. In another embodiment, a user may be aware only of a selection of item sources made by the user.

In one embodiment, a corpus of item sources is stored and associated with a user who contributed a selection of the plurality of item sources. In another embodiment, the corpus of item sources is included in the location of a feed made available to the user. The corpus of item sources could be included in the location as described further herein.

FIG. 4 shows a flow chart of an embodiment of a method 400 for updating a feed. In one embodiment, determining a previously-generated search result 402 in a feed includes inspection of items in the feed and comparison against a reference time. In another embodiment, determining a previously-generated search result 402 in a feed includes removing all items from the feed. For example, a feed may include items relating only to previously-generated search results. In one embodiment, a feed may include items which are not related to any search result. For example, a feed may include sponsored items or otherwise suggested items, also described further herein.

Determining a previously generated search result 402 in a feed may include many possible variations in implementation. In one embodiment, a feed contains an indication of the last time it was accessed. In another embodiment, the time a feed was most-recently accessed may be stored elsewhere. In one embodiment, the time a feed was last accessed may be compared against items contained within the feed. In another embodiment, the time a feed was last accessed may be compared against items taken from a search result.

In one embodiment, items which relate to a previously-generated search result are removed 404. Previously-generated search results may include, as discussed above, several definitions of search results. In one embodiment, all search results not relating to the presently generated search results are removed 404. In another embodiment, items which have been in the feed since it was last accessed are removed 404. For example, items which relate to older searches may have not been accessed by a user if a user's access of the feed is somehow disassociated with the initiation of a search which produces results that are incorporated into the feed.

In one embodiment, updating the feed 406 is performed once all items relating to previously-generated search results have been removed. In another embodiment, updating the feed 406 is performed intermittently and repetitively as items are removed in 404. Removing items in 404 and updating the feed in 406 are examples of method operations which may be performed iteratively, repeatedly, in tandem and/or in response to each other. Updating a feed 406 may be performed in any manner known in the art or otherwise described herein. For example, a feed may be created from a copy of the older version of the feed and the newer feed may be written over the older version of the feed.

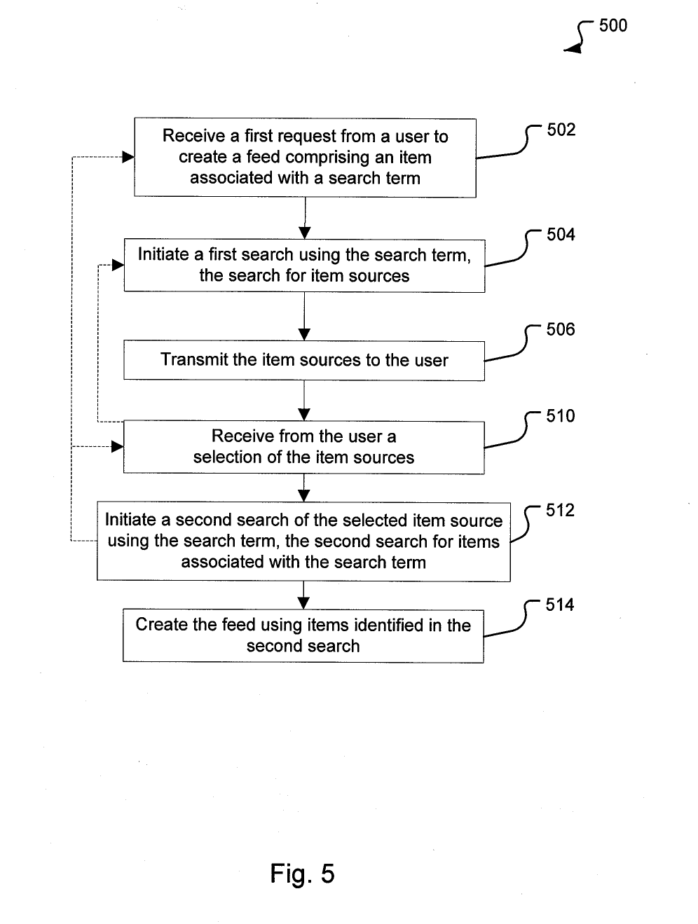

FIG. 5 shows a flow chart of an embodiment of a method 500 for creating a feed. A first request is received 502 from a user to create a feed. In one embodiment, the first request received in 502 is a request to create a persistent search using the feed. In another embodiment, the first request received in 502 is a repeated search request which is interpreted as a request to create a feed. In one embodiment, the received request may explicitly reference the feed. In another embodiment, the received request may be implicitly understood to request the creation of a feed. For example, a user may input a search term to a certain interface, the interface being related to a persistent search service. In yet another embodiment, a user may input a search term more than once, or may do so within a certain period of time, or may otherwise indicate a desire to repeat the search.

In one embodiment, the request includes search criteria such as a search term or an item source. In another embodiment, the request includes a suggestion of search criteria. For example, a user may submit an item as part of the user's request (where the item is referenced by an item source) where the item is an example of items that the user desires to have included in the feed and/or item sources that the user desires to be searched for items to include in the feed.

In response to the request received in 502, a first search may be initiated 504. The first search is for item sources and the first search uses the search term. In one embodiment, the first search may use other search criteria. For example, the search criteria used by the first search may include search criteria which is included in the request, which is suggested by the request, which is included in the search criteria as a sponsored search criterion, or which is otherwise part of the search criteria already existing before the first search as described further herein. In one embodiment, the first search for item sources is performed in a manner as described further herein. In one embodiment, the first search is initiated 504 to include all or a large number of item sources on a network, such as the Internet. In another embodiment, the first search is performed on a pre-determined set of item sources.

In the embodiment shown, item sources are transmitted to the user 506. Such transmission may be performed in any of the manners described further herein. In the embodiment shown, a selection of the item sources is received from the user 510, which may be performed in any of the manners described further herein.

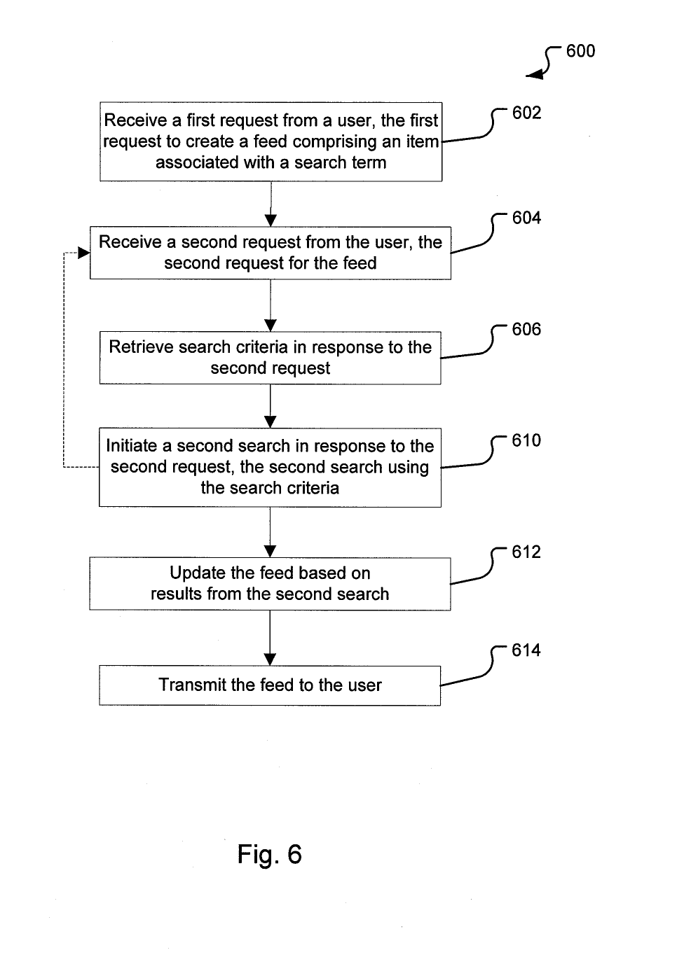

With the user's selection of item sources properly processed and included in the search criteria, a second search is initiated 512 for items associated with the search term. The second search for items may be initiated 512 in any of the manners described further herein. In one embodiment, the second search may be initiated 512 in response to receiving the selection of the item sources 510 from the user. In another embodiment, as described further herein (e.g., with respect to FIG. 6), the second search may be performed delayed from the receiving a selection 510, or in response to another triggering event. In one embodiment, the second search may be initiated 512 upon a receipt 510 of any selection of item sources from the user.

In one embodiment, the receipt 510 may be of a preliminary selection by a user. For example, a preliminary selection includes when a user moves a selection pointer (e.g., a mouse cursor, highlighting a selection box) over a selection. In another embodiment, the receipt 510 may be of a final selection by a user. For example, a final selection includes when a user indicates that the selection has been completed, such as through any action, as may be understood by users, which will close the selection process. For example, receiving an indication that a “submit” button was pressed by a user may indicate that the user has completed or finalized selection.

In one embodiment, in response to receiving a result (final or preliminary) of item sources 510, a search for item sources 504 may be initiated (see dashed line). For example, a search for item sources similar to the selected item source(s) may be performed. In one embodiment, this search for item sources may be performed using the search term and/or other search criteria as discussed further herein. For example, an indication of the user's preference for item sources may be determined from the selected item source (e.g., from 510) and the search for item sources (e.g., 504) may use this preference as a guide to finding further item sources. In another embodiment, implicit associations between related item sources can be used to select item sources for the second search.

In one embodiment, in response to receiving a preliminary selection 510, a second search is initiated 512 based on the preliminary selection. For example, in response to a user's mouse cursor being positioned over an item source, a preliminary result is received 510 of the item source selection and a second search is initiated 512 of the preliminarily-selected item source using the search term. In one embodiment, the search for items initiated in 512 takes into account and incorporates the search criteria thus far assembled. In another embodiment, the second search initiated in 512 is for items containing the search term from the item sources as selected by the user after the selection has been finalized by the user.

In one embodiment, when a second search was initiated 512 based on a preliminary item source selection, a result of the second search may be transmitted to a user during the user's continued selection of the item sources, or transmitted to the user before the user has otherwise finalized the selection. For example, in response to receiving 510 a preliminary item source selection, a search of the item source is initiated 512, and results from the item source are transmitted so that a user may view example results from the item source in response to the user's preliminary selection of the item source.

In one embodiment, as shown by the dashed line, a request to create a feed (e.g., a separate feed from the feed initially requested) may be received 502 in response to transmitting a result of the second search initiated in 512 on a preliminary selection received in 510. For example, a user may want a new feed to be created fitting one of the items transmitted. In one embodiment, a first search is initiated 504 for this new feed requested in 502, and the new feed is created in separate operations from the feed originally requested. In another embodiment, the creation of the new feed requested in 502 is merged to some extent with the creation of the feed originally requested.

In one embodiment, transmitting a result of a search for items (e.g., a result of 512) may trigger the receipt 510 from a user of a selection of another item source, as shown by the dashed line. For example, a user may see preliminary results of items based on a preliminary selection of item sources and may decide to select another source based on the items. In one embodiment, a log of events (e.g., a history) is stored along with the search criteria relating to the selection of the item sources, including the selection of the other item source by the user after the user receiving the preliminary results of items.

In one embodiment, results of a second search initiated 512 based on received preliminary results of item source selection may be saved with search criteria. For example, preliminary selection histories may be saved with search criteria along with the user's final selection of item sources. In one embodiment, the preliminary results of item source selection may be disregarded. In another embodiment, the preliminary results may be used to filter future search results. For example, an item may be excluded if it is referenced by an item source which was selected preliminarily but was later not selected for inclusion in the user's search criteria.

In one embodiment, item sources may be stored in search criteria with indications of usage of the item sources. For example, if items satisfying search criteria consistently are referenced by an item source, or if items from the item source are consistently downloaded or accessed by a user, the search criteria may indicate that the item source is a favored item source. In another embodiment, preliminary selection histories may be updated based on a user's usage of item sources, which may occur even if such preliminarily-selected item sources are not searched for items for inclusion in a feed. For example, two item sources may be counted as used if they both reference an item included in a feed, even if only one of the item sources was searched and the cause for including the item in the feed.

As used herein with relation to the searches in FIG. 5, the descriptors “first” and “second” do not limit or restrict the order or number of searches initiated in operations 504 and 512. As will be understood by the foregoing description, and the dashed lines in FIG. 5, each search may be initiated repeatedly and/or iteratively with various search criteria, and potentially in response to various requests/selections/instructions received from the user.

A feed may be created 514 using any results of items searched for in searches initiated 512 for those items. The feed may be created, stored, and/or presented to the user as described further herein.

FIG. 6 shows a flow chart of an embodiment of a method 600 of performing a search for items based on another triggering event. As shown in FIG. 6, a second request from a user is received 604, with the second request being for a feed. In the embodiment shown, the feed requested by the user (e.g., the request received in 604) has been first created based on a first request received 602 from the user to create the feed. The request received in 602 may be responded to in any manner described herein, including as described with respect to FIG. 5. It should be understood that search criteria, and, in some embodiments, a feed may have been created in response to the first request received in 602.

The second request received in 604 may be from a user or a software program requesting on behalf of the user, or another entity, such as described further herein.

The second request received in 604 may include, implicitly or explicitly, a request to update the feed. In one embodiment, the request for the feed may be interpreted as a request to update the feed by initiating a search 610 using part or all of stored search criteria associated with the feed and/or the user from whom the request was received.

In one embodiment, a search may be initiated 610 using all of the search criteria retrieved or so interpreted from the request. In another embodiment, a search may be initiated using only part of the search criteria associated with the feed and/or the user. In one embodiment, a second request received 604 from a user may include a request to use only part of the search criteria associated with the user. For example, a request received in 604 may include a request to update the feed only with search results from a particular item source or with items from item sources which reference items that the user has accessed since the last search. In another embodiment, a second request received 604 from a user may include a request to modify the search criteria associated with the user. For example, a user may request that a new item source be added, potentially just for one search, to the search criteria for updating the feed. In yet another embodiment, in response to the second request being received in 604, the search criteria may be modified to include or remove sponsored search criteria. Sponsored search criteria are further described herein.

Search criteria may be retrieved 606 from a memory or otherwise interpreted from the request (e.g., through the location of the feed requested), as described further herein. In one embodiment, search criteria are retrieved from a memory, and a temporary copy is made, possibly to be stored in a temporary memory, as will be understood by those with skill in the art. In another embodiment, search criteria or modifications to search criteria may be interpreted from the request received 604 for the feed.

Any request received to modify the search criteria (as described above) may be interpreted to be (or to include) a request to temporarily or permanently modify the search criteria. In one embodiment, based on the request received in 604 for the feed and any requests implicitly or explicitly to modify the search criteria, the retrieved temporary copy of the search criteria may be modified. In another embodiment, the search criteria may be modified in a memory where it is more permanently stored.

In one embodiment, in response to a request to modify the search criteria (e.g., within the request received in 604), a second search is initiated 610 based on the modified search criteria, and the results are transmitted to the user. This transmission may lead to the receipt 604 of another request for the feed (see dashed line). For example, a user may respond with an updated request 604 in a similar manner to the user's responses described with respect to FIG. 5. In one embodiment, the receipt 604 confirms the modification. In another embodiment, the receipt contains a different modification (or no modification at all) to the search criteria. For example, a user may receive feedback about how the request for the feed 604 containing a modification to search criteria will change the items contained in the results of searches using the modified search criteria. Upon receiving the feedback, the user may decide that the modifications to the search criteria should or should not be maintained.

In the embodiment shown, a search is initiated 610 with the search criteria as appropriately retrieved 606 (and/or interpreted) and potentially modified based on the request received in 604. The search initiated 610 is for items based on the search criteria. For example, the search may be for items referenced by the item sources contained in the search criteria and for items containing a search term. Other searches for items based on the search criteria are described further herein.

In the embodiment shown, the feed requested in 604 is updated 612 based on the results of the search initiated in 610. In one embodiment, updating a feed 612 may include retrieving a feed and modifying it. In another embodiment, a feed is updated 612 by creating from search results a document which appears to be an updated version of the feed. In one embodiment, a feed is assembled in a temporary memory which is cleared (or otherwise not used again) after the feed is transmitted to the user. In another embodiment, the feed is transmitted as it is updated in 612. Other methods of updating a feed are described further herein. It should be understood, as further described herein, that no requested or updated feed may exist as a file stored in the location requested. It should be also understood that the feed may be emulated to the user or aggregator requesting the feed.

In the embodiment shown, the feed is transmitted to the user 614. Transmitting the feed may be performed or modified as described herein and known in the art. For example, the contents of a feed may be transmitted to the entity requesting the feed, though no file identifiable as a feed exists in a non-temporary memory.

As those with skill in the art will understand, there are several methods of implementing syndication of an item source. For example, a feed may include all items referenced by the item source during a previous interval of time. As another example, a feed may be updated through including only new items, based on when the feed was last accessed by a user associated with the feed. Feeds may contain indications of times when items within the feed were updated.

As used herein the term reference should be understood as anything or any action that creates or enhances a path or access to a file or information. For example, a reference could be an association, a link, or otherwise linking to, hosting, mirroring, holding in cache, having a link to, or associating with a file or other piece of information. Those skilled in the art will appreciated other meanings of the term reference as well, as there are many methods, systems and schemas for creating paths and/or access. In one embodiment, a website may host a file itself. In another embodiment, a news aggregator may store and catalog links to files. In another embodiment, a blog may have postings containing text and links. In another embodiment, a website or server hosting a website may redirect a request sent to it for information which it references. In another embodiment, a reference could be a pointer to a system where the resource or item is dynamically generated on demand, e.g., from a database, without being a file in the system.

A sponsored item source, as used herein may include any source for which consideration is given or received based on a preference or inclusion. For example, a sponsored item source could include a source for which inclusion triggers compensation. Such inclusion could be at any stage, such as inclusion among choices of item sources presented to a user, inclusion in a feed, and inclusion in a list of item sources each time a feed is updated. A sponsored item source could also trigger consideration for the exclusion of item sources or types of information from a feed.

A search term as used herein may be any number of identifiers (e.g., words, terms or tags) used for searching. For example, a search term may include a list of words, a phrase, a word to be excluded from a search, a root of a word. Those with skill the art will understand the various common uses of a search term, and expansions thereof (e.g., using close terms, misspellings, synonyms, derivative words, etc.), for directing a search using the search term. Those with skill in the art will understand many ways of performing a search using a search term such as, for example, searching for items containing the search term, searching for items using the search term in a tag or metatag or other meta data, and searching for items linking to, or linked to by, other items containing the search term.

The terms contain and containing as used herein (e.g., items containing a search term) should be understood to refer to all ways of associating a search term with a item, document. For example, the containing the search term as a value of the document, tag, description line, referenced by another search engine, contained in a link to that item (the link contained in another item), known in the art.

The term item should be understood as any file or any piece of content. Items may include information in many forms, for example, a name of file, a descriptor of an HTML document, a location of a file, or a file itself. Examples of items include a media file, a document, a field in a database, and a web page. Those with skill in the art will understand other examples the term item fitting within the above definition.

The term feed may include any document which is written in a markup language or otherwise formatted to be read by a program expecting a markup language. Markup languages include extensible markup language (XML) and other RSS-compatible languages.

Creating a feed may be performed in many manners and those with skill in the art will be aware of formatting software which is capable of formatting information into a feed comprising a markup language or an RSS-compatible language. There are several coding techniques and markup languages now known and which will become known which may have different syntaxes, requiring different coding within feeds. Moreover, other languages besides markup languages may be used in similar manners. Those with skill in the art are aware of such different coding languages and methods of converting processes and code between languages.

Various RSS formats and aggregating software applications are described in the art. RSS may be used to syndicate information from a source of information. For example, a user or other entity may be interested in when a source of information updates the information it references. A feed may be used to describe what information is referenced by the source and an aggregating software application may check the file for updates. A common method of an aggregating software alerting a user for updates is the software checking if there is a new item in the feed, then notifying the user that the item source has been updated. The aggregating software may then also download the item from the item source to create a local copy of the item. A feed may also check for updates from multiple item sources.

There may be many types of item sources, which generally should be understood to mean any entity which references an item. For example, an item source may be a website, a publishing service, an archival service, a server, any entity with a URI, a news service, or a search engine. An item source may publish an item through making available an item, referencing an item, or presenting an item for public access over a network. The item source may also include or reference a feed which is also searchable for items.

While various embodiments have been described for purposes of this specification, various changes and modifications may be made which will readily suggest themselves to those skilled in the art and which are encompassed in the spirit of the invention both disclosed herein and as defined in the appended claims.

1. A method for customizing a feed, the method comprising:
receiving a request from a user for a feed, the feed comprising an item from a pre-identified corpus of item sources, the item being associated with a search term;
initiating a search using the search term, wherein the search is for items associated with the search term, the items referenced by at least one of the pre-identified corpus of item sources; and
creating the feed.

2. The method of claim 1, further comprising:
transmitting a plurality of item sources;
receiving a selection of the plurality of item sources from the user; and
creating the pre-identified corpus of item sources based on the selection received from the user.

3. The method of claim 1, further comprising:
updating the pre-identified corpus of item sources based on user information.

4. The method of claim 3, wherein user information is data selected from previous usage of feeds by the user, previous searches requested by the user, and the user's preferences.

5. The method of claim 1, wherein initiating comprises sending a search request to a third-party search engine.

6. The method of claim 1, wherein initiating comprises performing the search.

7. The method of claim 1, further comprising:
determining one or more previously generated search results.

8. The method of claim 7, wherein determining the one or more previously generated search results is performed based on the time the request from the user was received.

9. The method of claim 7, further comprising:
removing from the feed an item which is part of the one or more previously generated search results.

10-12. (canceled)

13. A method, comprising:
receiving a first request from a user to create a feed, the feed comprising an item, the item being associated with a search term;
initiating a first search using the search term, wherein the first search is for one or more item sources;
transmitting, to the user, the one or more item sources;
receiving, from the user, a selection of at least one item source from the one or more item sources;
initiating a second search of the selected at least one item source using the search term, wherein the second search is for items associated with the search term; and
creating the feed using items identified in the second search.

14. The method of claim 13, wherein the first request includes the search term.

15. The method of claim 13, further comprising:
receiving a second request from the user, the second request being a request for the feed;
wherein the initiating the second search is performed in response to the second request.

16. The method of claim 15, further comprising:
retrieving, in response to the second search request, the search term and the selected at least one item source.

17. (canceled)

18. The method of claim 13, further comprising:
storing search criteria associated with the user, the search criteria identifying the search term and the selected at least one item source.

19. (canceled)

20. The method of claim 19, wherein user information is data selected from previous usage of feeds by the user, previous searches requested by the user, and the user's preferences.

21. (canceled)

22. The method of claim 13, wherein initiating the first search comprises sending a search request to a third-party search engine.

23. The method of claim 13, wherein initiating the first search comprises performing the first search.

24. A system, comprising:
a search criteria manager that receives search criteria associated with a user, the search criteria including a first item source and a search term;
a search manager in communication with the search criteria manager, wherein the search manager initiates a first search, wherein the first search is for items associated with the search term, the items referenced by the first item source; and
a feed manager in communication with the search criteria manager and with the search manager, wherein the feed manager formats items contained in a first result of the first search as a feed and makes the feed available to the user.

25. The system of claim 24, wherein the search manager initiates a second search for second item sources, the second search using the search term.

26. The system of claim 24, wherein the search criteria manager updates the search criteria based on user information.

27. The system of claim 26, wherein user information is data selected from previous usage of feeds by the user, previous searches requested by the user, and the user's preferences.

28. The system of claim 24, wherein the search criteria manager transmits a plurality of second item sources to the user and receives a selection of the second item sources from the user.

29. The system of claim 28, wherein the first item source is part of the selection of the second item sources received from the user.

30. (canceled)

31. The system of claim 24, wherein, in response to a subsequent request for the feed, the search criteria manager updates the feed by requesting the search manager to initiate a third search of the first item source, wherein the third search is for items associated with the search term, the items referenced by the first item source.

32. The system of claim 24, further comprising:
a timing module in communication with the search criteria manager, wherein the timing module instructs the search criteria manager to update the feed.
33-35. (canceled)
